(19) United States
(12) Patent Application Publication
(10) Pub. No.: US 2014/0261510 A1
(43) Pub. Date: Sep. 18, 2014

(54) Dental Plaque Removal Device

(71) Applicants: Daniel B. Stiefel, Longmeadow, MA (US); David P. Rossiter, III, South Hadley, MA (US); Shannon M. Santana, New Salem, MA (US); Marissa Brown, Chicopee, MA (US); Alyssa Adoretti, Sterling, MA (US); Marianne Peura-Wolff, Sunderland, MA (US)

(72) Inventors: Daniel B. Stiefel, Longmeadow, MA (US); David P. Rossiter, III, South Hadley, MA (US); Shannon M. Santana, New Salem, MA (US); Marissa Brown, Chicopee, MA (US); Alyssa Adoretti, Sterling, MA (US); Marianne Peura-Wolff, Sunderland, MA (US)

(21) Appl. No.: 13/834,519

(22) Filed: Mar. 15, 2013

(51) Int. Cl. A61C 15/04

(52) U.S. Cl. CPC A61C 15/046
USPC 132/200; 132/323; 132/325

(57) ABSTRACT

A kit for dental plaque removal comprises a longitudinally extending absorbent dental strip and a holder. The absorbent dental strip has a thickness “t” and a width “w.” T is sized to be receivable in edentulous areas and diastemas, and w is sized to clean the surface of a tooth without protruding past a gingival sulcus and damaging gingival tissue. The holder has a main shaft. A pair of laterally spaced prongs project from a first end of the main shaft. The prongs are configured to reversibly secure a length of the absorbent dental strip.

### BACKGROUND OF THE DISCLOSURE

The present disclosure relates to dental hygiene devices, and more particularly, to a dental plaque removal kit.

Plaque and calculus build-up are well-known precursors to a host of dental problems such as periodontal disease and gingivitis. Dental floss and dental tape are traditionally utilized to prevent plaque and calculus buildup between teeth. Though dental floss and dental tape fit easily in the small spaces between teeth, they are not effective at cleaning the surface of teeth above the gingival margin, and can harm the gingival tissue in locations where teeth are not in direct contact with one another.

Additionally, traditional dental floss and dental tape are ill-suited for cleaning areas where teeth are not in direct contact with one another such as edentulous areas in the mid-arch, teeth adjacent diastemas, and the distal aspect of the posterior-most teeth. Periodontal floss and other thick, woven dental flosses are traditionally used to clean areas where dental floss or dental tape is inadequate. Though better suited to clean in areas where there are larger spaces between teeth than traditional floss, periodontal floss does not completely clean the surface of teeth above the gingival margin, and cannot completely remove plaque stains.

Accordingly there is a need in the market for a dental plaque removal device that thoroughly cleans large spaces between teeth and removes greater amounts of plaque than prior art devices.

### SUMMARY

Briefly stated, the dental plaque removal kit comprises a longitudinally extending absorbent dental strip and a holder. The absorbent dental strip has a thickness “t” and a width “w.” The thickness t is sized to be received in edentulous areas of the mid-arch or in diastemas without damaging gingival tissue. The width “w” is sized so as to clean a substantial portion of a surface of a tooth without protruding past the gingival sulcus.

In one embodiment the absorbent dental strip is precut into a plurality of strips for inclusion with the kit. In an alternate embodiment the dental strip is wrapped around a spool and installed in the cavity of a container.

The holder has a main shaft having first and second ends. The first end has a pair of laterally spaced prongs configured to reversibly secure a length of the absorbent dental strip. The second end of the holder may have a structure for cleaning in between closely spaced teeth.

A method of cleaning a surface of a tooth is also contemplated in connection with the instant disclosure. A patient or dental professional places the absorbent dental strip of the current disclosure against the surface of the tooth above the gingival tissue. Properly placed, the absorbent dental strip is repeatedly manipulated laterally across the surface of the tooth. The lateral manipulations are repeated until a desired volume of plaque is removed from the surface of the tooth.

The dimensions of the absorbent dental strip of the present disclosure confer an advantage over traditional dental floss. The thickness t and width w of the absorbent dental strip provide more surface area, making the dental strip easier manipulate and provide a larger cleaning surface. The larger dimensions also render the absorbent dental strip safer than traditional floss. If introduced in the area below the gingival margin the thickness t of the dental strip has a relatively blunted edge. Consequently, a patient or dental professional must use a substantially greater amount of force to cause trauma to the gingival tissue in comparison with prior art flosses.

The device and method of the current disclosure clean a substantial amount of plaque and stain from the surface of the tooth in comparison to prior art devices. The absorbent dental strip of the present disclosure produced superior results in comparison with dental floss, dental tape, and periodontal floss when the cleaning capabilities were tested on plaque stains.

### BRIEF DESCRIPTION OF THE DRAWINGS

Aspects of the preferred embodiment will be described in reference to the Drawing, where like numerals reflect like elements:

FIG. 1 shows one embodiment of a kit for removing dental plaque;

FIG. 2 shows one embodiment of a kit for removing dental plaque where the absorbent dental strip is pre-attached to the holder; and

FIG. 3 shows an alternate embodiment of the holder having a modified first end;

FIG. 4 shows an alternate embodiment of the holder of FIG. 1 having a modified second end;

FIG. 5 shows an alternate embodiment of the holder of FIG. 1 having a modified second end;

FIG. 6 shows an alternate embodiment of the holder of FIG. 1 having a modified second end; and

FIG. 7 shows a partially cutaway view of a box for use with the kit of the current disclosure.

### DETAILED DESCRIPTION OF THE PREFERRED EMBODIMENTS

Embodiments of a dental plaque removal device will now be described with reference to the Figures, wherein like numerals represent like parts throughout the Figures. FIG. 1 depicts a plaque removal kit 100. The kit 100 comprises a longitudinally extending absorbent dental strip 102 and a holder 104.

The dental strip 102 is configured to effectively clean surfaces of teeth adjacent edentulous areas and diastemas. The dental strip 102 has a thickness “t” sized to be receivable in edentulous areas and diastemas, and a width “w” sized to clean a surface of a tooth (not shown). The thickness t is specifically chosen to permit the absorbent dental strip to fit below the gingival margin (not shown) without damaging the gingiva. The ratio of t:w is optimized to allow the patient or dental professional to clean the maximum amount of surface area of the crown, while reducing the risk of gingival trauma. In one embodiment w is one centimeter and t is one-half millimeter.

The dental strip 102 comprises a longitudinally continuous strip of woven material selected for its absorbent and pliable characteristics. In one embodiment the woven material comprises a longitudinal strip of cotton having a thread count and weave pattern similar to that of a t-shirt. In another embodiment the woven material comprises medical grade gauze.

The absorbent properties of the dental strip 102 confer important advantages over dental floss and dental tape. The dental strip 102 may be impregnated with any of a plurality of suitable dental agents. Fluoride varnish and other desensitizing agents are one example of potential dental agents.

Referring to FIGS. 1 and 2, the holder 104 has a main shaft 106 and first and second ends 108 and 110, respectively. A pair of laterally spaced prongs 112 project from the first end of the main shaft 106. The prongs 112 are configured to secure a length of the dental strip 102, to facilitate cleaning the surface of a tooth. Slots 114, sized to be slightly deeper than the width w and slightly wider than the thickness t of the dental strip 102, may be formed at the distal-most ends of the prongs 112.

In the embodiment shown in FIGS. 1-2 and 4-6, the prongs extend from the holder first end 108 of the main shaft 106 and are laterally spaced from one another to form a Y-shape. In an alternate embodiment shown in FIG. 3, the prongs 112 are laterally spaced from one another to form a P-shape.

A dental cleaning apparatus 116 is formed in the holder second end 110. In the embodiment shown in FIGS. 1-3, the cleaning apparatus 116 is a tooth pick. As shown in FIGS. 4, 5 and 6, the apparatus may alternatively comprise an end-tuft toothbrush 117 (FIG. 4), a rubber tipped dental stimulator 119 (FIG. 5), or an interdental brush 121 (FIG. 6).

In one embodiment of the kit 100 depicted in FIG. 2, the dental strip 102 is pre-attached to the holder 104. The dental strip 102 may be attached to the holder 104 using any method known in the art.

In an alternate embodiment, the dental strip 102 is pre-cut into a plurality of pre-determined lengths and secured to the prongs 112 via the slots 114. As shown in FIGS. 4-6, the dental strip 102 may also be secured to the prongs 112 via a bollard or cleat 113 located at the junction of the prongs 112. The dental strip 102 is secured to the holder 104 by wrapping longitudinal ends of the dental strip 102 around the bollard 113. The dental strip 102 is held in place between the prongs by the slots 114. Alternatively, channels 115 may run the length of the prongs 112 to secure the dental strip 102 between the prongs 112.

As shown in FIG. 7, the kit may include a container 120 designed to receive a spool 118. A length of the dental strip 102 is coiled around the spool 118 and received in a cavity defined by a bottom wall 122 and a plurality of vertical walls 124.

A cutting assembly 125 generally comprises a lid 126, a stopper 132, a first cutter 134, an insert 136 and a second cutter 138. The lid 126 has a plurality of lid walls 127 which define a lid cavity 130. The lid 126 is connected to at least one of the vertical walls 124 by a hinge 128. In the embodiment shown in FIG. 7, the hinge 128 is a living hinge.

The walls 127 of the lid 126 are sized so that the stopper 132 and first cutter project into the lid cavity 130 and interact with the second cutter 138 to cut a desired length of the dental strip 102. Upon angularly rotating the lid 126 about the hingeable connection 128 until the lid walls 127 contact the vertical walls of the container 124, the first and second cutters 134 and 138 cooperate to sever a length of the dental strip 102 from the coiled length around the spool 118.

In use, the dental strip 102 cleans the crown of the tooth above the gingival margin and into the sulcus below the gingival margin. To clean these areas the dental strip is placed on the surface of the tooth above the gingiva. The dental strip is then repeatedly laterally manipulated until a desired volume of plaque is removed.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

1. A dental plaque removal kit comprising:
a longitudinally extending absorbent dental strip having a thickness “t” sized to be receivable in edentulous areas and diastemas and a width “w” sized to clean a substantial portion of a surface of a tooth without protruding past a gingival sulcus; and
a holder having a main shaft having first and second ends, said first end having a pair of laterally spaced prongs, each of said prongs configured for reversibly securing a length of said absorbent dental strip.

2. The dental plaque removal kit of claim 1, wherein said absorbent dental strip comprises a woven material.

3. The dental plaque removal kit of claim 2, wherein said absorbent dental strip comprises a continuous longitudinally extending piece of medical gauze.

4. The dental plaque removal kit of claim 2, wherein said woven material comprises cotton.

5. The dental plaque removal kit of claim 1, wherein said absorbent dental strip is impregnated with a dental agent.

6. The dental plaque removal kit of claim 5, wherein said dental agent is fluoride varnish.

7. The dental plaque removal kit of claim 1, wherein said absorbent dental strip is wrapped around a spool.

8. The dental plaque removal kit of claim 7, wherein said spool is received in a container, said container having a bottom wall and a plurality of vertical container walls defining an opening, a cutting assembly comprising a lid having a hingeable connection with at least one of said vertical walls, a plurality of lid walls defining a cavity, a first cutter and a stopper projecting into said cavity, and an insert received in said container opening defining an outlet sized to receive said width and thickness of said absorbent dental strip and a second cutter configured to cooperate with said first cutter, wherein upon angularly rotating said lid about said hingeable connection until said lid walls contact said vertical container walls said first and second cutters cooperate to sever a portion of said absorbent dental strip from said spool.

9. The dental plaque removal kit of claim 1, wherein said prongs extend from said shaft and are laterally spaced from one another in a Y-shape.

10. The dental plaque removal kit of claim 1, wherein said prongs extend from said shaft and are laterally spaced from one another in a P-shape.

11. The dental plaque removal kit of claim 1, wherein t is approximately one-half millimeter and w is approximately one centimeter.

12. The dental plaque removal kit of claim 1, wherein said holder second end has a dental cleaning apparatus.

13. The dental plaque removal kit of claim 13, wherein the dental cleaning apparatus comprises a toothpick.

14. The dental plaque removal kit of claim 13, wherein the dental cleaning apparatus comprises an end-tuft toothbrush.

15. The dental plaque removal kit of claim 13, wherein the dental cleaning apparatus comprises a rubber tipped dental stimulator.

16. The dental plaque removal kit of claim 13, wherein the dental cleaning apparatus comprises an interdental brush.

17. A method of cleaning a surface of a tooth above a gingival sulcus comprising:
providing a longitudinally extending absorbent dental strip having a width w and a thickness t;
placing said absorbent dental strip on the surface of the tooth above the gingival sulcus; and
repeatedly manipulating said absorbent dental strip laterally across the surface of the tooth until a desired volume of dental plaque is removed from the surface of the tooth.

18. The method of cleaning a surface of a tooth of claim 13, further comprising securing first and second ends of said absorbent dental strip at first and second laterally spaced prongs of a holder.

19. The method of cleaning a surface of a tooth of claim 13, further comprising impregnating said absorbent dental strip with a dental agent before placing said absorbent dental strip on the surface of the tooth.

20. The method of cleaning a surface of a tooth of claim 13, wherein the surface of the tooth is one of either the lingual surface of a posterior-most tooth, tthe surface of a tooth adjacent an edentulous area, or the surface of a tooth adjacent a diastema.
